(19) United States
(12) Patent Application Publication
(10) Pub. No.: US 2014/0178526 A1
(43) Pub. Date: Jun. 26, 2014

(54) NUTRIENT-DENSE MULTIPLEX COMESTIBLES

(71) Applicant: LUBY'S FUDDRUCKERS RESTAURANTS, LLC, Houston, TX (US)

(72) Inventors: Daniel Phalen, Houston, TX (US); Jamille Bond, Houston, TX (US)

(73) Assignee: LUBY'S FUDDRUCKERS RESTAURANTS, LLC, HOUSTON, TX (US)

(21) Appl. No.: 13/725,757

(22) Filed: Dec. 21, 2012

(51) Int. Cl. A23L 1/308

(52) U.S. Cl. CPC A23L 1/308
USPC 426/2; 426/615

(57) ABSTRACT

Provided herein are nutrient-dense multiplex comestibles as well as methods of their use and processes to produce such multiplex comestibles.

### SUMMARY OF THE INVENTION

Disclosed herein is a multiplex comestible product comprising the following components: i) a flavoring comprising a cultivar of solanum lycopersicum; ii) a homogenized leafy green vegetable having at least 5,000 IU of Vitamin A per 100 g and at least 250 micrograms of Vitamin K per 100 g in its raw form; wherein the volume ratio of flavoring to homogenized leafy green vegetable is between about 1.0 and 5.5 prior to product preparation; iii) a homogenized non-tuberous root vegetable having at least 10,000 IU of Vitamin A per 100 g in its raw form; wherein the volume ratio of flavoring to homogenized root vegetable is between about 1 and 9 prior to product preparation; iv) either a meat selected from the group consisting of: beef, turkey, and/or chicken; or a meat substitute product; iv) optionally a homogenized variety of cucurbitaceae; wherein the volume ratio of flavoring to homogenized cucurbitaceae is between about 15.0 and 18.0 prior to product preparation; and v) optionally a cultivar of capsicum annuum having greater than 100 mg of Vitamin C per 100 g in its raw form, wherein the volume ratio of flavoring to homogenized capsicum annuum is between 7 and 9.0 prior to product preparation; wherein the product is severable into at least about twenty apportionments of about 150 to about 450 kilocalories, wherein each apportionment comprises the following: a) at least about three grams of fiber; b) at least about 2000 IU of Vitamin A; and c) at least about 20 mg of Vitamin C. In some embodiments, the leafy green vegetable is Spinacia oleracea and the non-tuberous root vegetable is Daucus carota. In some embodiments, the product further comprises: i) a homogenized variety of cucurbitaceae; wherein the volume ratio of flavoring to homogenized cucurbitaceae is between about 15.0 and 18.0 prior to product preparation, wherein the variety of cucurbitaceae is Cucurbita pepa; and ii) a cultivar of capsicum annuum having greater than 100 mg of Vitamin C per 100 g in its raw form, wherein the volume ratio of flavoring to homogenized capsicum annuum is between 7 and 9.0 prior to product preparation. In some embodiments, each apportionment comprises at least five grams of fiber. In some embodiments, each apportionment comprises at least 2500 IU of vitamin A and at least 22 mg of vitamin C. In some embodiments, the meat or meat substitute product is homogenized or partially homogenized, and the components are admixed to be uniformly distributed throughout the product.

Also disclosed herein, in some embodiments, is a multiplex comestible product comprising the following components: i) a partially homogenized meat, wherein the source of the meat is selected from a member of the Thunnus genera Thunnus and Gallus gallus; ii) a homogenized variety of brassicaceae having greater than 30 mg of Vitamin C per 100 g in its raw form, wherein the volume ratio of partially homogenized meat to homogenized brassicaceae is between and 17 and 25 by weight prior to product preparation; and iii) a binder and/or flavoring that is reduced calorie and reduced sodium; wherein the product is severable into at least about twenty apportionments ranging in calorie value from 50 and 150 kilocalories, wherein each apportionment comprises at least 0.25 grams of fiber. In some embodiments, the homogenized variety of brassicaceae is Brassica oleracea. In some embodiments, the product further comprises a species of Apiaceae. In some embodiments, each apportionment comprises at least 0.50 grams of fiber. In some embodiments, each apportionment comprises at least 0.75 grams of fiber. In some embodiments, each apportionment comprises at least 1.0 grams of fiber. In some embodiments, each apportionment comprises at least 3 mg of vitamin C. In some embodiments, each apportionment comprises at least 30 IU of vitamin A.

In some embodiments, disclosed herein is a process of producing a multiplex comestible product comprising admixing the following components: i) a flavoring comprising a cultivar of solanum lycopersicum; ii) a homogenized leafy green vegetable having at least 5,000 IU of Vitamin A per 100 g and at least 250 micrograms of Vitamin K per 100 g in its raw form; wherein the volume ratio of flavoring to homogenized leafy green vegetable is between about 1.0 and 5.5 prior to product preparation; iii) a homogenized non-tuberous root vegetable having at least 10,000 IU of Vitamin A per 100 g in its raw form; wherein the volume ratio of flavoring to homogenized root vegetable is between about 1 and 9 prior to product preparation; iv) either a meat selected from the group consisting of: beef, turkey, and/or chicken; or a meat substitute product; v) optionally a homogenized variety of cucurbitaceae; wherein the volume ratio of flavoring to homogenized cucurbitaceae is between about 15.0 and 18.0 prior to product preparation; and vi) optionally a cultivar of capsicum annuum having greater than 100 mg of Vitamin C per 100 g in its raw form, wherein the volume ratio of flavoring to homogenized capsicum annuum is between 7 and 9.0 prior to product preparation; and severing the product into at least about twenty apportionments of from 150 to about 450 kilocalories, such that each apportionment of the product comprises one or more of the following: a) at least about three grams of fiber; b) at least about 2000 IU of Vitamin A; and c) at least about 20 mg of Vitamin C. In some embodiments, the leafy green vegetable is Spinacia oleracea and the non-tuberous root vegetable is Daucus carota. In some embodiments, the multiplex comestible product further comprises a variety of cucurbitaceae, wherein the variety of cucurbitaceae is Cucurbita pepa.

Also disclosed herein is a method of increasing fiber intake in an individual in need thereof comprising administering a multiplex comestible product, as disclosed herein. In some embodiments, the individual is below the age of 18 years or above the age of 65 years.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### DETAILED DESCRIPTION OF THE INVENTION

Nutrient-dense comestible products provide minerals, vitamins, and other substances that, in some embodiments, have positive health effects, with relatively few calories. In some embodiments, disclosed herein are nutrient-dense comestible products that are lean or low in solid fats, and minimize or exclude added sugars, and added refined starches, as these add calories but few essential nutrients or dietary fiber. In some embodiments, nutrient-dense comestible products also minimize or exclude added salt or other compounds high in sodium. In some embodiments, disclosed herein are nutrient-dense comestible products that have higher levels of dietary fiber, compared to similar non-nutrient dense comestible products. All fat-free or low-fat milk and milk products, vegetables, fruits, whole grains, seafood, lean meats and poultry, eggs, beans and peas (legumens), and nuts and seeds that are prepared without added sugars, solid fats, starches, and sodium are nutrient-dense.

Most vegetables and fruits are major contributors of a number of nutrients that are underconsumed in the United States, including folate, magnesium, potassium, dietary fiber, and vitamins A, C, and K.

Consumption of fruits and vegetables is associated with reduced risk of many chronic diseases. It has been shown that intake of at least 2½ cups of vegetables and fruits per day is associated with a reduced risk of cardiovascular disease, including heart attack and stroke. In some embodiments, vegetables and fruits are protective against certain types of cancer.

Most vegetables and fruits, when prepared without added sugars or fats, are relatively low in calories. Eating higher levels of fruits and vegetables instead of higher calorie foods can help children and adults achieve and maintain a healthy weight. However, for almost all Americans ages 2 years and older, usual intake of vegetables and fruits falls below recommended amounts.

### Fiber

Fiber is the non-digestible carbohydrates and lignin that are intrinsic and intact in plants. Fiber consists of dietary fiber (the fiber naturally occurring in foods) and functional fiber, which are isolated, nondigestible carbohydrates that have beneficial physiological effects in humans. Sources of dietary fiber include vegetables, fruits, whole grains, and nuts. Dietary fiber helps provide a feeling of fullness and is important in promoting healthy laxation.

A low-fiber diet has been linked to numerous diseases and disorders, such as gastrointestinal disease (e.g., constipation, diverticulosis, irritable bowel syndrome), cancer, coronary heart disease, diabetes, hyperlipidemia, and obesity.

The adequate intake (AI) for fiber is 14 g per 1,000 calories, or 25 grams per day for women and 38 grams per day for men. For children, ages 3 to 18 years, the recommended daily intake of dietary fiber is equal to the child's age plus five. Bread products made with refined flour are not high in dietary fiber, but currently contribute substantially to dietary fiber consumption because of their ubiquity in typical American diets. In some embodiments, an increase in the consumption of beans and peas, other vegetables, fruits, whole grains, and other foods with naturally occurring dietary fiber in an individual contributes to the individual meeting the recommendation for adequate daily intake of fiber.

### Vitamin A

Vitamin A is a fat-soluble vitamin that is naturally present in many foods. There are two different types of vitamin A: preformed vitamin A and provitamin A. Preformed vitamin A is found in meat, poultry, fish and dairy products. Provitamin A, also known as beta-carotene, is found in fruits (e.g., cantaloupe, apricots, and mangos), vegetables (e.g., green leafy vegetables and other green, orange, and yellow vegetables such as broccoli, carrots, and squash) and other plant-based products.

Vitamin A is important for normal vision, immune function, reproduction, and cellular communication. Vitamin A also supports cell growth and differentiation, impacting the normal formation and maintenance of the heart, lungs, kidneys and other organs.

Deficiency in vitamin A intake can manifest in xerophthalmia (inability to see in low light) as well as a diminished ability to fight off infection. Research has shown that high consumption of foods containing beta-carotene may lead to lower risk of certain types of cancer, such as lung cancer or prostate cancer. Vitamin A supplementation is used to treat severe measles in pediatric patients as well as age-related macular degeneration.

The USDA recommends a Daily Value (DV) of 5,000 IU (international units) of vitamin A for adults and children aged 4 years and older.

### Vitamin C

Vitamin C, also known as ascorbic acid, is a water-soluble nutrient found in some foods. Vitamin C has antioxidant activity, assists in the production of collagen, improves the absorption of iron from plant-based foods, and helps the immune system to protect the body from disease.

Fruits and vegetables are the best sources of vitamin C. Such fruits and vegetables include citrus fruits (e.g., oranges and grapefruit), red and green peppers, kiwifruit, broccoli, strawberries, cantaloupe, and tomatoes.

Vitamin C deficiency can lead to anemia, bleeding gums, dry and splitting hair, gingivitis, swollen joints, increased tendency to bruise, and increased susceptibility to infection. Severe vitamin C deficiency can lead to scurvy.

Daily recommended amounts of vitamin C depend on age. Children under 18 years of age should get 15-75 milligrams of vitamin C. Adults should get 75-90 milligrams of vitamin C.

### Vitamin K

Vitamin K is a fat-soluble vitamin mostly found in vegetables, especially green vegetables such as kale, collards, spinach, broccoli, and cabbage. Vitamin K is involved with normal blood clotting and is important in the production of bone proteins.

Vitamin K deficiency can lead bleeding of the gums, nose bleeds, heavy menstrual bleeding, increased tendency to bruise, hemorrhaging, and anemia. In some instances, vitamin K deficiency leads to excessive calcium deposition in soft tissues, hardening arteries. Consequently, prolonged deficiency in vitamin K results in osteoporosis and/or coronary heart disease.

Daily recommended amounts of vitamin K for adequate intake are 120 micrograms/day for male adults, 90 micrograms/day for female adults, 15-100 micrograms/day for children and adolescents, and 10-20 micrograms/day for infants.

### Methods of Use

It is estimated that by the year 2050, 20% of the American population will be 65 or older. Older adults have decreased energy needs, mainly due to muscle mass decrease and changes in metabolism and appetite. In addition, concomitant conditions of cognitive impairment and functional limitations may adversely affect nutritional status for the elderly. Overall, these circumstances hinder the intake of fiber rich food in older adults. The intake for most Americans, including those aged 70 years or older, is 14-16 grams/day [T. S. Dharmarajan; J. Ravunniarath; C. S. Pitchumoni. Practical Gastroenterology (February 2003), 43-58].

In addition, in many instances, children are finicky eaters, refusing to taste or eat items presented to them at mealtimes. Texture, taste, and appearance of these food items play major roles as to why children reject certain foods, such as vegetables. As a result, achieving and maintaining a balanced diet for children can be a challenging task. This can be especially trying in a hospital setting, where injured or sick children really need adequate nutrition in order to regain health. In some embodiments, the nutrient-dense multiplex comestible products as disclosed herein serve as a source of additional full or partial servings of fruits and/or vegetables when incorporated as part of a daily balanced diet. These products obscure the appearance and taste of the homogenized fruits and/or vegetables, making it more likely that these products are consumed.

One embodiment provides a method of increasing fiber intake in an individual in need thereof comprising administering a multiplex comestible product as described herein to the individual. Another embodiment provides a method wherein the individual is below the age of 18 years or above the age of 65 years. Another embodiment provides a method wherein the individual is below the age of 18 years. Another embodiment provides a method wherein the individual is at or above the age of 65 years.

### DEFINITIONS

The term “homogenize” as used herein describes the action of reducing to fairly uniform consistency. In some embodiments, homogenization of diverse elements also leads to even distribution of the resultant small particles. Homogenization includes pureeing, grinding and grating. In some embodiments, homogenization is performed using electrical or hand-operated equipment, such as a blender, a food processor, or a mixer. In some embodiments, homogenization is performed by hand, with or without hand-operated tools or equipment. In some embodiments, homogenization is performed by a combination of actions by hand and by electrical and/or hand-operated tools or equipment. “Partial homogenization” refers to reduction to non-uniform smaller size. Partial homogenization includes shredding, tearing, cutting, splitting, chopping, dicing, and crumbling. In some embodiments, partial homogenization of diverse elements leads to uneven distribution of non-uniformly smaller sized elements. In some embodiments, homogenization or partial homogenization of a component is performed before the application of any temperature change to the component, such as heating, boiling, steaming, baking, roasting, sautéing, or frying. In some embodiments, homogenization or partial homogenization is performed after the application of any temperature change.

A binder and/or flavoring that is “reduced calorie” has at least 25% fewer calories per serving than a comparative reference food, wherein the reference food is not “low calorie.”

In some embodiments, the term “low sodium” describes 140 mg or less of sodium per serving. In some embodiments, a low sodium meal or prepared dish contains 140 mg or less of sodium per 100 gram serving.

A binder and/or flavoring that is “reduced calorie” “reduced sodium” describes at least 25% less sodium per serving than a comparative reference food, wherein the reference food is not “low sodium.” In some embodiments, a reduced sodium meal or prepared dish is at least 25% less sodium per 100 gram serving than an appropriate reference meal or prepared dish.

The term “leafy green vegetable” describes vegetables also known as potherbs, greens, vegetable greens, leafy greens, or salad greens. Non-limiting examples include kale, collards, turnip greens, swiss chard, spinach, mustard greens, broccoli, arugula, red and green leaf and romaine lettuce, cabbage, and iceberg lettuce.

The term “binder” describes food materials used in the preparation of a dish for the purpose of enabling smaller components to adhere to one another and pack together with minimal crumbling of the overall structure. These binders typically have mild flavoring by themselves, but can be flavored by mixture with other additives, such as spices or flavoring. Non-limiting examples include eggs and mayonnaise.

The term “flavoring” describes a food material that imparts a flavor when used during the preparation of a dish. Non-limiting examples of flavoring include spices, salt, pepper, fruit juice, oils, pastes, sauces, artificial flavoring, and plant extracts.

The term “base flavoring” describes a food material that imparts a dominant flavor when used in the preparation of a dish. Non-limiting examples of base flavoring include tomato, meat, and cream.

### Nutrient Dense Comestible Products

In some embodiments, disclosed herein are methods of increasing overall intake of fruits and vegetables in an individual by supplementation of homogenized fruits and/or vegetables in comestible products eaten by the individual. In some embodiments, homogenized fruits and/or vegetables enhances the taste, texture, and nutrient value of the comestible products. In some embodiments, homogenized fruits and/or vegetables increase the intake of fiber as well as the intake of minerals and vitamins such as vitamins A, C, and K. Concomitant substitution of food elements with low/reduced calorie or low/reduced sodium replacements provides a nutrient-dense multiplex comestible product.

Nutrient-dense multiplex comestible products as disclosed herein appeal to adults of all ages, especially those with selective palates and/or for whom advanced age has hindered adequate food intake. Consumption of nutrient-dense multiplex comestible products containing high levels of minerals, vitamins, and dietary fiber assist in fulfilling the overall health needs of the consumer by increasing nutrient density, promoting healthy lipid profiles and glucose tolerance, and ensuring normal gastrointestinal function.

Disclosed herein, in some embodiments, is a multiplex comestible product comprising the following components:

i) a flavoring comprising a cultivar of solanum lycopersicum;

ii) a homogenized leafy green vegetable having at least 5,000 IU of Vitamin A per 100 g and at least 250 micrograms of Vitamin K per 100 g in its raw form; wherein the volume ratio of flavoring to homogenized leafy green vegetable is between about 1.0 and 5.5 prior to product preparation;

iii) a homogenized non-tuberous root vegetable having at least 10,000 IU of Vitamin A per 100 g in its raw form; wherein the volume ratio of flavoring to homogenized root vegetable is between about 1 and 9 prior to product preparation;

iv) either a meat selected from the group consisting of: beef, turkey, and/or chicken; or a meat substitute product;

iv) optionally a homogenized variety of cucurbitaceae; wherein the volume ratio of flavoring to homogenized cucurbitaceae is between about 15.0 and 18.0 prior to product preparation; and

v) optionally a cultivar of capsicum annuum having greater than 100 mg of Vitamin C per 100 g in its raw form, wherein the volume ratio of flavoring to homogenized capsicum annuum is between 7 and 9.0 prior to product preparation;

wherein the product is severable into at least about twenty apportionments of about 150 to about 450 kilocalories, wherein each apportionment comprises the following:

a) at least about three grams of fiber;

b) at least about 2000 IU of Vitamin A; and

c) at least about 20 mg of Vitamin C. In some embodiments is provided a multiplex comestible product wherein the leafy green vegetable is Spinacia oleracea and the non-tuberous root vegetable is Daucus carota. Another embodiment provides a multiplex comestible product further comprising a cultivar of capsicum annuum, wherein the cultivar of capsicum annuum is selected from red bell peppers or green bell peppers. Another embodiment provides a multiplex comestible product further comprising a variety of cucurbitaceae, wherein the variety of cucurbitaceae is Cucurbiata pepa.

In some embodiments is provided a multiplex comestible product wherein the base flavoring comprises a cultivar of solanum lycopersicum. In some embodiments is provided a multiplex comestible product wherein the base flavoring comprises Bos primigenius. In some embodiments is provided a multiplex comestible product wherein the base flavoring comprises a cultivar of solanum lycopersicum and Bos primigenius.

Another embodiment provides a multiplex comestible product wherein the base flavoring comprises a cultivar of solanum lycopersicum, the leafy green vegetable is Spinacia oleracea and the non-tuberous root vegetable is Daucus carota. Another embodiment provides a multiplex comestible product wherein the base flavoring comprises a cultivar of solanum lycopersicum and the ratio of flavoring to Spinacia oleracea is about 3:2 by volume prior to product preparation. Another embodiment provides a multiplex comestible product wherein the base flavoring comprises a cultivar of solanum lycopersicum, the ratio of flavoring to Spinacia oleracea is about 3:2 by volume prior to product preparation and the ratio of flavoring to Daucus carota is about 3:1 by volume prior to product preparation. Another embodiment provides a multiplex comestible product wherein the base flavoring comprises a cultivar of solanum lycopersicum, the ratio of flavoring to Spinacia oleracea is about 3:2 by volume prior to product preparation and the ratio of flavoring to Daucus carota is about 3:4 by volume prior to product preparation.

Another embodiment provides a multiplex comestible product wherein the flavoring comprises a cultivar of solanum lycopersicum, the leafy green vegetable is Spinacia oleracea, the non-tuberous root vegetable is Daucus carota, the variety of cucurbitaceae is Cucurbiata pepa, and the cultivar of capsicum annuum is red bell peppers. A further embodiment provides a multiplex comestible product wherein the base flavoring comprises a cultivar of solanum lycopersicum, the ratio of flavoring to Spinacia oleracea is about 16:3 by volume prior to product preparation, the ratio of flavoring to Daucus carota is about 8:1 by volume prior to product preparation, the ratio of flavoring to Cucurbiata pepa is about 16:1 by volume prior to product preparation, and the ratio of flavoring to red bell peppers is about 8:1 by volume prior to product preparation.

One embodiment provides a multiplex comestible product wherein the flavoring comprises a cultivar of solanum lycopersicum, the leafy green vegetable is Spinacia oleracea, the non-tuberous root vegetable is Daucus carota, and the cultivar of capsicum annuum is green bell peppers. Another embodiment provides a multiplex comestible product wherein the base flavoring comprises a cultivar of solanum lycopersicum, the ratio of flavoring to Spinacia oleracea is about 5:16 by volume prior to product preparation, the ratio of flavoring to Daucus carota is about 5:12 by volume prior to product preparation, and the ratio of flavoring to green bell peppers is about 5:4 by volume prior to product preparation.

Another embodiment provides a multiplex comestible product wherein the base flavoring comprises a cultivar of solanum lycopersicum and the ratio of flavoring to Spinacia oleracea is between 3 and 7 by weight prior to product preparation. Another embodiment provides a multiplex comestible product wherein the base flavoring comprises a cultivar of solanum lycopersicum, the ratio of flavoring to Spinacia oleracea is between 3 and 7 by weight prior to product preparation and the ratio of flavoring to Daucus carota is between 3 and 7 by weight prior to product preparation. Another embodiment provides a multiplex comestible product wherein the base flavoring comprises a cultivar of solanum lycopersicum, the ratio of flavoring to Spinacia oleracea is between 3 and 7 by weight prior to product preparation and the ratio of flavoring to Daucus carota is between 3:4 and 3:2 by weight prior to product preparation.

Another embodiment provides a multiplex comestible product wherein the base flavoring comprises a cultivar of solanum lycopersicum, the ratio of flavoring to Spinacia oleracea is between 15 and 21 by weight prior to product preparation, the ratio of flavoring to Daucus carota is between 10 and 16 by weight prior to product preparation, the ratio of flavoring to Cucurbiata pepa is between 14 and 20 by weight prior to product preparation, and the ratio of flavoring to red bell peppers is between 14 and 20 by weight prior to product preparation.

Another embodiment provides a multiplex comestible product wherein the base flavoring comprises a cultivar of solanum lycopersicum, the ratio of flavoring to Spinacia oleracea is between 1 and 3:2 by weight prior to product preparation, the ratio of flavoring to Daucus carota is between 1:2 and 1:1 by weight prior to product preparation, and the ratio of flavoring to green bell peppers is between 3:2 and 2:1 by weight prior to product preparation.

In some embodiments, provided herein is a multiplex comestible product wherein each apportionment comprises at least 0.25 grams of fiber per serving. In some embodiments, each apportionment comprises at least 0.5, 0.75, 1.0, 1.25, 1.5, 1.75, 2, 3, 4, 5, 6, 7, 8, 9, 10, 11, 12, 13, 14, or 15 grams of fiber.

In some embodiments, provided herein is a multiplex comestible product wherein each apportionment comprises at least 2000 IU of vitamin A. In some embodiments, each apportionment comprises at least 2500, at least 3000, at least 3500, at least 4000, at least 5000, at least 6000, or at least 7000 IU of vitamin A.

In some embodiments, provided herein is a multiplex comestible produce wherein each apportionment comprises at least 20 milligrams of vitamin C. In some embodiments, each apportionment comprises at least 21, at least 22, at least 23, at least 24, or at least 25 mg of vitamin C.

Disclosed herein, in some embodiments, is a multiplex comestible product comprising the following components:

i) a partially homogenized meat, wherein the source of the meat is selected from a member of the Thunnus genera Thunnus and Gallus gallus;

ii) a homogenized variety of brassicaceae having greater than 30 mg of Vitamin C per 100 g in its raw form, wherein the volume ratio of partially homogenized meat to homogenized brassicaceae is between and 17 and 25 by weight prior to product preparation; and

ii) a binder and/or flavoring that is reduced calorie and reduced sodium;

wherein the product is severable into at least about twenty apportionments ranging in calorie value from 50 and 150 kilocalories, wherein each apportionment comprises at least 0.5 grams of fiber. Another embodiment provides a multiplex comestible product wherein the homogenized variety of brassicaceae is Brassica oleracea. Another embodiment provides a multiplex comestible product wherein the homogenized variety of brassicaceae is Brassica oleracea and the binder and/or flavoring is selected from one or more of the following: low calorie mayonnaise and low sodium chicken base. Another embodiment provides a multiplex comestible product wherein the homogenized variety of brassicaceae is Brassica oleracea and the binder and/or flavoring is low calorie mayonnaise. Another embodiment provides a multiplex comestible product wherein the partially homogenized meat comprises one or more of the following: a member of the Thunnus genus, Gallus gallus, Meleagris gallpavo, or a member of the Oncorhynchus genus. Another embodiment provides a multiplex comestible product wherein the partially homogenized meat is selected from a member of the Thunnus genus and Gallus gallus. Another embodiment provides a multiplex comestible product wherein the homogenized variety of brassicaceae is Brassica oleracea, the binder and/or flavoring is low calorie mayonnaise and low sodium chicken base, and the partially homogenized meat is Gallus gallus. Another embodiment provides a multiplex comestible product wherein the homogenized variety of brassicaceae is Brassica oleracea, the binder and/or flavoring is low calorie mayonnaise, and the partially homogenized meat is selected from a member of Thunnus genus. A further embodiment provides a multiplex comestible product wherein the partially homogenized meat is Thunnus alalunga.

Another embodiment provides a multiplex comestible product wherein the ratio of partially homogenized meat to homogenized brassicaceae is between 10 and 30 by weight prior to product preparation. Another embodiment provides a multiplex comestible product wherein the ratio of partially homogenized meat to homogenized brassicaceae is between 15 and 25 by weight prior to product preparation. Another embodiment provides a multiplex comestible product wherein the ratio of partially homogenized meat to homogenized brassicaceae is between 15 and 40 by weight prior to product preparation. Another embodiment provides a multiplex comestible product wherein the ratio of partially homogenized meat to homogenized brassicaceae is between 20 and 30 by weight prior to product preparation. Another embodiment provides a multiplex comestible product wherein the ratio of partially homogenized meat to homogenized brassicaceae is between 20 and 25 by weight prior to product preparation. Another embodiment provides a multiplex comestible product wherein the ratio of partially homogenized meat to homogenized brassicaceae is about 21 by weight prior to product preparation.

Another embodiment provides a multiplex comestible product wherein the ratio of flavoring to homogenized brassicaceae is between 1:1.6 and 1:2 by weight prior to product preparation. Another embodiment provides a multiplex comestible product wherein the ratio of flavoring to homogenized brassicaceae is between 1:1.7 and 1:1.9 by weight prior to product preparation. Another embodiment provides a multiplex comestible product wherein the ratio of flavoring to homogenized brassicaceae is between 1:1.9 and 1:2.1 by volume prior to product preparation. Another embodiment provides a multiplex comestible product wherein the ratio of flavoring to homogenized brassicaceae is about 1:2 by volume prior to product preparation.

In some embodiments, provided herein is a multiplex comestible product wherein each apportionment comprises at least 0.25 grams of fiber. Another embodiment provides a multiplex comestible product wherein each apportionment comprises at least 0.50 grams of fiber Another embodiment provides a multiplex comestible product wherein each apportionment comprises at least 0.75 grams of fiber.

In some embodiments, provided herein is a multiplex comestible product wherein each apportionment comprises at least 3 milligrams of vitamin C.

In some embodiments, provided herein is a multiplex comestible product wherein each apportionment comprises at least 25 IU of vitamin A.

Disclosed herein, in some embodiments, is a process of producing a multiplex comestible product comprising admixing the following components:

i) a flavoring comprising a cultivar of solanum lycopersicum;

ii) a homogenized leafy green vegetable having at least 5,000 IU of Vitamin A per 100 g and at least 250 micrograms of Vitamin K per 100 g in its raw form; wherein the volume ratio of flavoring to homogenized leafy green vegetable is between about 1.0 and 5.5 prior to product preparation;

iii) a homogenized non-tuberous root vegetable having at least 10,000 IU of Vitamin A per 100 g in its raw form; wherein the volume ratio of flavoring to homogenized root vegetable is between about 1 and 9 prior to product preparation;

iv) either a meat selected from the group consisting of: beef, turkey, and/or chicken; or a meat substitute product;

iv) optionally a homogenized variety of cucurbitaceae; wherein the volume ratio of flavoring to homogenized cucurbitaceae is between about 15.0 and 18.0 prior to product preparation; and

v) optionally a cultivar of capsicum annuum having greater than 100 mg of Vitamin C per 100 g in its raw form, wherein the volume ratio of flavoring to homogenized capsicum annuum is between 7 and 9.0 prior to product preparation;

and severing the product into at least about twenty apportionments of from 150 to about 450 kilocalories, such that each apportionment of the product comprises one or more of the following:

a) at least about three grams of fiber;

b) at least about 2000 IU of Vitamin A; and

c) at least about 20 mg of Vitamin C. In some embodiments, the leafy green vegetable is Spinacia oleracea and the non-tuberous root vegetable is Daucus carota. In some embodiments, the multiplex comestible product further comprises a variety of cucurbitaceae, wherein the variety of cucurbitaceae is Cucurbiata pepa. In some embodiments, the multiplex comestible product further comprises a cultivar of capsicum annuum, wherein the cultivar of capsicum annuum is selected from red bell peppers or green bell peppers. In some embodiments, the multiplex comestible product further comprises a variety of cucurbitaceae, wherein the variety of cucurbitaceae is Cucurbiata pepa. In some embodiments, the base flavoring comprises a cultivar of solanum lycopersicum. In some embodiments is provided a process wherein the base flavoring comprises Bos primigenius. In some embodiments is provided a process wherein the base flavoring comprises a cultivar of solanum lycopersicum and Bos primigenius. In some embodiments, the product is heated prior to consumption. In some embodiments, the product is subjected to a temperature between 100° F. and 400° F.

Disclosed herein, in some embodiments, is a process to produce a multiplex comestible product comprising admixing the following components:

a. a partially homogenized meat;

b. a homogenized variety of brassicaceae having greater than 30 milligrams of vitamin C per 100 grams in its raw form, wherein the ratio of partially homogenized meat to homogenized brassicaceae is between 10 and 40 by weight prior to product preparation; and

c. a binder and/or flavoring that is reduced calorie and reduced sodium; and severing the product into at least about twenty apportionments of from 40 to 200 kilocalories, wherein each apportionment of the product comprises at least 0.25 grams of fiber.

### EXAMPLES

### Example 1

### Turkey Chili

192×(4 oz servings chili on 3 oz brown rice), 340 calories/serving, 9.49 grams fiber, 7089 IU vitamin A, 24 units vitamin C

| Volume | Weight | Components |
|---|---|---|
| 8 gallons | | onions, ½ inch diced |
| 4 gallons | 9280 grams | carrots, ½ inch diced |
| 8 quarts | 2264 grams | spinach, fresh leaf, firm packed |
| 12 quarts | 11616 grams | tomatoes, crushed |
| 1 cup | | garlic, chopped |
| 1⅓ cup | | kosher salt |
| 4 cups | | chili powder |
| 40 pounds | | ground turkey, 90/10 |
| As needed | | pan spray |
| 8 cups | | cornmeal |
| 1 cup | 287 grams | vegetable base |
| 8 quarts | | water, hot |
| 4 gallons | | pinto beans, cooked |
| 8 gallons | | brown rice, cooked |

Onions, carrots, spinach, tomatoes, garlic, seasoning salt, and chili pepper were homogenized to a fine consistency. Ground turkey was thoroughly heated and drained of any fats and oil prior to mixing with the homogenized vegetables. The resultant mixture was treated at low heat prior to slow mixing with cornmeal, a solution of vegetable base in hot water, and the pinto beans. The final mixture was gently heated to between 180-205° F.

### Example 2

### Beef Taco Filling

88×(1 tortilla w/2 oz taco filling & 0.5 oz shredded cheese); 314 calories/serving; 2.29 grams fiber, 1630 IU vitamin A, 7 units of vitamin C

| Volume | Weight | Components |
|---|---|---|
| 8 cups | | onions, ½ inch diced |
| 4 cups | 580 grams | carrots, ½ inch diced |
| 8 cups | 566 grams | spinach, fresh leaf, firm packed |
| 12 cups | 2904 grams | tomatoes, diced, canned |
| 4 tbsp | | garlic, chopped |
| 6 tbsp | | kosher salt |
| 1 cup | | chili powder |
| 10 pounds | | ground beef, 90/10 |
| As needed | | pan spray |
| (88 pieces) | | 6″ wheat flour tortilla |
| 44 ounces | | cheddar cheese, shredded |

Onions, carrots, spinach, tomatoes, garlic, seasoning salt, and chili pepper were homogenized to a fine consistency. Ground beef was thoroughly heated and drained of any fats and oil prior to mixing with the homogenized vegetables. The resultant mixture was gently heated to between 180-205° F.

### Example 3

### Marinara Sauce

10 quarts: serving size is 1 ounce; 16 calories/serving, 1.5 grams fiber, 1100 IU vitamin A, 12 units vitamin C

| Volume | Weight | Components |
|---|---|---|
| 4 cups | | onions, rough chop |
| 4 cups | 580 grams | carrots, rough chop |
| 6 cups | 425 grams | spinach, fresh leaf, firm packed |
| 4 cups | 750 grams | red peppers, rough chop |
| 2 cups | 470 grams | yellow squash, rough chop |
| 4 quarts | 3872 grams | tomatoes, diced |
| 4 quarts | 3968 grams | tomato sauce |
| 2 ounces | | garlic, chopped |
| 2 tbsp | | kosher salt |
| 2 tbsp | | black pepper, table grind |
| 4 tbsp | | Italian seasoning |
| 2 tbsp | | brown sugar |
| As needed | | pan spray |

Spinach was finely homogenized prior to repeated homogenization following the addition of onions, peppers, carrots, yellow squash, garlic, salt, pepper, and Italian seasoning. This resultant homogenized mixture was treated at medium heat before addition of tomatoes, tomato sauce, and brown sugar. The final mixture was gently heated to between 180-205° F.

### Example 4

### Spaghetti with Meat Sauce

100×(4 oz pasta w/4 oz sauce); 198 calories/serving; 6 grams fiber, 1765 IU of vitamin A, 19 units of vitamin C

| Volume | Weight | Components |
|---|---|---|
| 4 cups | | onions, rough chop |
| 4 cups | 580 grams | carrots, rough chop |
| 6 cups | 425 grams | spinach, fresh leaf, firm packed |
| 4 cups | 750 grams | red peppers, rough chop |
| 2 cups | 470 grams | yellow squash, rough chop |
| 4 quarts | 3872 grams | tomatoes, diced |
| 4 quarts | 3968 grams | tomato sauce |
| 2 ounces | | garlic, chopped |
| 2 tbsp | | kosher salt |
| 2 tbsp | | black pepper, table grind |
| 4 tbsp | | Italian seasoning |
| 2 tbsp | | brown sugar |
| As needed | | pan spray |
| 22 pounds | | ground turkey |
| 14 pounds | | Spaghetti noodles |

Spinach was finely homogenized prior to repeated homogenization following the addition of onions, peppers, carrots, yellow squash, garlic, salt, pepper, and Italian seasoning. A third homogenization was performed after the addition of diced tomatoes. Ground turkey was heated to an internal temperature of 165° F., drained of any excess fats and oil, and mixed with the homogenized vegetables. After heating at medium heat, tomato sauce and brown sugar were added. The resultant mixture was gently heated to between 180-205° F. prior to serving over cooked spaghetti.

### Example 5

### Mini Meatloaf

54×(4 oz servings meatloaf w/1.5 oz Example 3), 281 calories/serving; 1.77 grams fiber, 1498 IU of vitamin A, 8 units of vitamin C

| Volume | Weight | Components |
|---|---|---|
| 4 cups | | yellow onions, rough chop |
| 3 cups | 435 grams | carrots, rough chop |
| 4 cups | 283 grams | spinach, fresh leaf, firm packed |
| 1 cup | 187 grams | green bell peppers, rough chop |
| 12 ounces | 340 grams | tomato paste |
| 3 cups | | eggs, liquid |
| 4 cups | | cracker meal |
| 4 cups | | oats |
| 4 tbsp | | kosher salt |
| 4 tbsp | | black pepper, table grind |
| 12 pounds | | ground Angus beef, 90/10 |
| As needed | | pan spray |
| 10 cups | | Marinara Sauce (see Example 3) |

Onions, carrots, spinach, and bell peppers were homogenized to a fine consistency prior to thorough and even mixture with ground beef, eggs, cracker meal, oats, tomato paste, salt, and pepper. Resultant mixture was heated until the internal temperature reached 155° F. Final product was served with 1.5 oz of Example 3.

### Example 6

### Turkey Sliders

160×(2⅔ oz patty w/bun, ½ slice cheese); 248 calories/serving; 1.68 grams fiber, 1035 IU of vitamin A, 4 units of vitamin C

| Volume | Weight | Components |
|---|---|---|
| 8 cups | | yellow onions, rough chop |
| 6 cups | 435 grams | carrots, rough chop |
| 8 cups | 283 grams | spinach, fresh leaf, firm packed |
| 2 cups | 187 grams | green bell peppers, rough chop |
| 24 ounces | 340 grams | tomato paste |
| 6 cups | | eggs, liquid |
| 8 cups | | cracker meal |
| 8 cups | | oats |
| 8 tbsp | | kosher salt |
| 8 tbsp | | black pepper, table grind |
| 24 pounds | | ground turkey, 90/10 |
| As needed | | pan spray |
| (80 slices) | | American cheese slices, cut in half diagonally |
| (160 each) | | hamburger bun |

Onions, carrots, spinach, and bell peppers were homogenized to a fine consistency prior to thorough and even mixture with ground turkey, eggs, cracker meal, oats, tomato paste, salt, and pepper. Resultant mixture was separated into smaller portions and each portion was heated until the internal temperature reached 155° F. Final product was served with a bun.

### Example 7

### Chicken Salad

8 quarts (serving size?); 134 calories/serving; 0.58 gram fiber, 85 IU of vitamin A, 9 units of vitamin C

| Volume | Weight | Components |
|---|---|---|
| 3 pounds | 1361 grams | chicken, white meat |
| 1.5 gallons | 5670 grams | water |
| 1 tsp | 6 grams | chicken base, low sodium |
| 1.5 cup | | celery-diced |
| ½ cup | 120 grams | light mayonnaise |
| 1 cup | 220 grams | cauliflower, pureed |
| 1.5 tsp | 16 grams | salt |
| 1 tsp | 3 grams | pepper |

The chicken was heated until an internal temperature of 165° F. was reached and then shredded prior to mixture with the other components.

### Example 8

### Tuna Salad

8 quarts (serving size?); 69 calories/serving; 0.29 grams fiber, 38 IU of vitamin A, 3 units of vitamin C

| Volume | Weight | Components |
|---|---|---|
| 3 pounds | 1361 grams | cooked tuna, water packed, drained |
| 1.5 cup | | celery, ¼″ dice |
| ½ cup | 120 grams | light mayonnaise |
| 1 cup | 220 grams | cauliflower, pureed |
| 1.5 tsp | 16 grams | salt |
| 1 tsp | 3 grams | pepper |

All components were mixed together.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-6. (canceled)

7. A process of producing a comestible product comprising admixing the following components:
i) a partially homogenized meat, wherein the source of the meat is selected from a member of the Thunnus genera Thunnus and Gallus gallus domesticus;
ii) a homogenized variety of brassicaceae in its raw form and having greater than 30 mg of Vitamin C per 100 g, wherein the volume ratio of partially homogenized meat to homogenized brassicaceae is between and 17 and 25 by weight prior to product preparation; and
iii) a binder and/or flavoring that is reduced calorie and reduced sodium;
and severing the product into at least about twenty apportionments ranging in calorie value from 50 to about 150 kilocalories, wherein each apportionment comprises at least 0.5 grams of fiber.

8. The process according to claim 7 wherein the homogenized variety of brassicaceae is Brassica oleracea.

9. The process according to claim 7, wherein the product further comprises a species of Apiaceae.

10. The process according to claim 7 wherein each apportionment comprises at least 0.75 grams of fiber.

11. The process according to claim 7 wherein each apportionment comprises at least 1.0 grams of fiber.

12. The process according to claim 7 wherein each apportionment comprises at least 3 mg of vitamin C.

13. The process according to claim 7 wherein each apportionment comprises at least 30 IU of vitamin A.

14. A process of producing a comestible product comprising admixing the following components:
i) a flavoring comprising a cultivar of solanum lycopersicum;
ii) a homogenized leafy green vegetable in its raw form and having at least 5,000 IU of Vitamin A per 100 g and at least 250 micrograms of Vitamin K per 100 g; wherein the volume ratio of flavoring to homogenized leafy green vegetable is between about 1.0 and 5.5 prior to product preparation;
iii) a homogenized non-tuberous root vegetable in its raw form and having at least 10,000 IU of Vitamin A per 100 g; wherein the volume ratio of flavoring to homogenized root vegetable is between about 1 and 9 prior to product preparation;
iv) either a meat selected from the group consisting of: beef, turkey, and/or chicken; or a meat substitute product;
v) optionally a homogenized variety of cucurbitaceae; wherein the volume ratio of flavoring to homogenized cucurbitaceae is between about 15.0 and 18.0 prior to product preparation; and
vi) optionally a cultivar of capsicum annuum in its raw form and having greater than 100 mg of Vitamin C per 100 g in its raw form, wherein the volume ratio of flavoring to homogenized capsicum annuum is between 7 and 9.0 prior to product preparation;
and severing the product into at least about twenty apportionments of from 150 to about 450 kilocalories, such that each apportionment of the product comprises one or more of the following:
a) at least about three grams of fiber;
b) at least about 2000 IU of Vitamin A; and
c) at least about 20 mg of Vitamin C.

15. The process of claim 14 wherein the leafy green vegetable is Spinacia oleracea and the non-tuberous root vegetable is Daucus carota subsp. sativus.

16. The process of claim 14 wherein the comestible product further comprises a variety of cucurbitaceae, wherein the variety of cucurbitaceae is Cucurbita pepo.

17. A method of increasing fiber intake in an individual in need thereof comprising administering a product of claim 1 to the individual.

18. A method of claim 17, wherein the individual is below the age of 18 years or above the age of 65 years.

19. A method of increasing fiber intake in an individual in need thereof comprising administering a product of claim 7 to the individual.

20. A method of claim 19, wherein the individual is below the age of 18 years or above the age of 65 years.
